(19) United States
(12) Patent Application Publication
(10) Pub. No.: US 2008/0133767 A1
(43) Pub. Date: Jun. 5, 2008

(54) REAL-TIME MULTICAST PEER-TO-PEER VIDEO STREAMING PLATFORM

(75) Inventors: Stefan Birrer, Evanston, IL (US); David Choffnes, Chicago, IL (US); Noah S. Clemons, Evanston, IL (US); Andrea C. Heusser, Chicago, IL (US); Adam P. Johnson, Chicago, IL (US); Andreas Schuler, Des Plaines, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Metis Enterprise Technologies LLC, Evanston, IL (US)

(21) Appl. No.: 11/944,458

(22) Filed: Nov. 22, 2007

Related U.S. Application Data
(60) Provisional application No. 60/866,926, filed on Nov. 22, 2006.

(51) Int. Cl. G06F 15/16

(52) U.S. Cl. 709/231

(57) ABSTRACT

A peer-to-peer platform makes use of a streaming agent running at each peer. The streaming agent causes a peer to receive chunks of content from different neighboring peers, store some of the chunks in a local cache, and distribute those cached chunks to neighboring peers. Delivering next generation broadcasts (e.g., as streams of live audio and digital media) of any size utilizing the Internet is achieved. Users can view a live or prerecorded stream of a broadcast through an integrated media player, or can replay a broadcast through an integrated, intelligent archiving service. Use of the platform reduces bandwidth demands on live streaming and archiving services to a level where it is sustainable within a profitable business model to offer the services for at most a negligible fee.

### CROSS-REFERENCE TO RELATED APPLICATIONS

This patent application claims the benefit of U.S. Provisional Patent Application No. 60/866,926, filed Nov. 22, 2006.

### FIELD OF THE INVENTION

This invention pertains generally to the field of computer content delivery and more particularly to the area of transmission of video over peer-to-peer networks.

### BACKGROUND

The use of peer-to-peer file sharing networks has grown in recent years. The most well-known of these “P2P” networks allowed users to share static, stored files (such as music files) from their own personal computers with other users. The general idea around these historical P2P networks has been to create virtual file servers through a collection of peer computers. Instead of going to a single source for a file, a user in one of these P2P networks would instead obtain the file from one of his peers on the network. The user typically would also act as a server by uploading his own files for others to download.

While various types of P2P file sharing networks have been developed, most have focused on file sharing capabilities. These P2P networks do not lend themselves well for the transmission of streamed live content, where latency and upload bandwidth requirements impose additional constraints on a networking system.

### BRIEF SUMMARY OF THE INVENTION

A peer-to-peer platform makes use of a streaming agent running at each peer. The streaming agent causes a peer to receive chunks of content from different neighboring peers, store some of the chunks in a local cache, and distribute those cached chunks to neighboring peers. Thus, methods and systems are provided for delivering next generation broadcasts (e.g., as streams of live audio and digital media) of any size utilizing the Internet. For example, users can view a live or prerecorded stream of a broadcast through an integrated media player, or can replay a broadcast through an integrated, intelligent archiving service. Use of the platform reduces bandwidth demands on live streaming and archiving services to a level where it is sustainable within a profitable business model to offer the services for at most a negligible fee.

A user connecting to a hybrid peer-to-peer (P2P) network (e.g., a peer-to-peer network that not only relies on the computing power and bandwidth of participants in the network, but also the storage capacity, bandwidth, and back-end intelligence of controllers in a robust file system), as described herein is provided the ability to broadcast live media content and is afforded several advantages over previous distribution technology. For example, the platform allows for an unlimited number of users, connected with a network of limitless simultaneous live streams being broadcast to a limitless number of viewers. The platform further supports the highest quality audio and video formats and can adapt to support advancing audio and video formats.

The cost of implementing the platform is minimal. The system architecture provides an affordable live streaming video service over the Internet. The streaming protocol utilized by the platform reduces the demand for a content provider's bandwidth, and thus significantly reduces the cost of providing the service, often to the point where the streaming service can be offered for free. An archiving and storage system enables archiving of media files, e.g., audio and/or video files, within the platform as they are being live broadcasted over the network or uploaded to an archiving server and/or dedicated peer.

The streaming platform is a mesh-based hybrid, using a mesh for control and a per-packet tree for data delivery. Trees are built by each peer independently before the corresponding packet is produced. The control mesh also serves as a backup for the per-packet data delivery tree. The streaming protocol uses swarming not for the initial delivery, but for recovering packets that a host may have missed, because it was unable to join the associated packet delivery tree, or may have experienced a loss during transmission. The initial data distribution utilizes ahead-of-time, per-packet trees, allowing for longer-term data exchange relationships when compared to pure meshes. The relationships help reduce the overhead of the system while incorporating the mesh's advantages in short-term adaptivity and fairness. Packet optimization, for example, based on node classes (such as desktop nodes or in-network servers). To provide maximal network efficiency, packet requests are performed in phases, first looking to minimize cross-ISP traffic and link stress, and eventually going for a more selfish response-time approach independent of network cost. Both the control mesh and the delivery trees are built based on static information (such as prefix, AS mapping or noted type, i.e., leaf or super-peer) and dynamic information, in particular end-to-end throughput and latency, which are all passively measured.

Using the described platform, content can be streamed for immediate viewing with minimal delay. The described hybrid P2P network ensures that there will be no extraneous buffering time involved with the live streaming or archived viewing, so that users experience instant viewing of the media files much like that experiences with broadcast television. Achieving low delivery latency in live content distribution has previously proven difficult to achieve. The ability to deliver content to a large set of peers in a short interval differentiates live streaming from conventional content distribution where access latency is a non-issue. The streaming protocol and hybrid P2P network specifically address challenges in the live streaming domain including, but not limited to, delivery latency, overhead, bitrate scalability, as would be needed to broadcast HD quality media files, for example.

To support proprietary rights an owner may have in the content, the platform allows content to be recorded to a persistent storage only with the permission of the content provider, and support for this option is provided as independent task for storage on the viewer's computer.

The described platform includes technology designed to expand the scope and capabilities of a live streaming service. The ability to receive streams in the proposed invention is not bounded by region and is not limited to those with high bandwidth and financial resources. Viewers are offered a portal where they can view whatever is happening anywhere in the world, as it is happening.

The described platform further includes support for evolving communication paradigms, and can accommodate the expansion of Wi-Fi networks, the growing availability of Internet connections as a whole, increases in Internet bandwidth availability, and integration of computer and television, and emergence of portable media players and other embedded devices with connectivity to the Internet.

Use of the described platform and technology is accomplished in a user-friendly manner, such that any computer-literate person with a high-speed Internet connection and a device that produces audio/video content (e.g., a video camera) can stream continuous live feeds to other users, either through a central host site or through their own website, inexpensively and easily.

Thus, embodiments of the invention provide a novel infrastructure that competes in the existing online media distribution market. Previously existing platforms did not offer a fully automated, deployable, real-time streaming multicast that reduced content providers' bandwidth demands to such a degree.

In one aspect, a method is provided for receiving a stream of electronic content in a network of interconnected peer computing devices, the method comprising notifying a directory server with a request for the stream, receiving a response identifying a set of the peer computing devices from which the stream's content can be retrieved, receiving, substantially simultaneously, at least a first distinct portion of the stream from a first peer computing device in a calculated subset of the set of peer computing devices, and at least a second distinct portion of the stream from a second peer computing device in the calculated subset, and assembling at least the first portion and the second portion into a presentable form.

In another aspect, a system is provided for distributing electronic content in an interconnected network of computing devices comprising an instance of electronic content, the instance partitioned into a plurality of substantially equally sized portions, a source computing device for initially transmitting the instance of content onto the network, at least one consumer computing device on the network for receiving the instance of content, a directory server for helping identify a first set of computing devices on the network from which the consumer computing device can receive portions of the content, and an agent executing at the consumer computing device for receiving the identification of the first set from the directory server, causing distinct portions of the instance of content to be received from distinct computing devices within a calculated subset of the first set, and assembling the distinct portions into a presentable form.

In still another aspect, a method is provided for broadcasting a live content stream to a multiplicity of users on an interconnected peer-to-peer network, the method comprising registering the content stream with a directory server, receiving, from the directory server, a list of identified computing devices on the network to which distinct portions of the content stream are to be sent, and transmitting a first of the distinct portions of the content stream to a first of the identified computing devices, and a second of the distinct portions to a second of the identified computing devices.

In yet another aspect, a method is provided for managing the on-demand retrieval of a stream of content by computing devices on an interconnected peer-to-peer network, the method comprising partitioning the stream into a plurality of distinct stream partitions, determining that a first archiving computing device connected to the network is to store at least one of the distinct stream partitions, storing one or more stream partitions at the first archiving computing device, receiving a request for the stream of content from a first consuming computing device connected to the network, determining that the first consuming computing device is to store at least one of the distinct stream partitions, storing at least one of the stream partitions at the first consuming computing device, receiving a request for the stream of content from a second consuming computing device, and causing the plurality of distinct stream partitions to be transmitted through the peer-to-peer network to the second consuming computing device, including at least one partition from the first archiving computing device and at least one partition from the first consuming computing device.

### BRIEF DESCRIPTION OF THE SEVERAL VIEWS OF THE DRAWING(S)

While the appended claims set forth the features of the present invention with particularity, the invention and its advantages are best understood from the following detailed description taken in conjunction with the accompanying drawings, of which:

FIG. 1 is a general overview of components in a multicast real-time peer-to-peer streaming network, in accordance with an embodiment of the invention;

FIG. 2 is a diagram illustrating a distributed streaming arrangement, in accordance with an embodiment of the invention;

FIG. 3 is a diagram illustrating a variety of tiers of service in a peer-to-peer streaming network, in accordance with an embodiment of the invention;

FIG. 4 is a block diagram illustrating components of a streaming agent for use in a peer-to-peer streaming network, in accordance with an embodiment of the invention;

FIG. 5 is a block diagram illustrating components of a directory service for use in a peer-to-peer streaming network, in accordance with an embodiment of the invention;

FIG. 6 is a diagram illustrating components of an archiving service for use in a peer-to-peer streaming network, in accordance with an embodiment of the invention;

FIG. 7 is a block diagram illustrating an exemplary archiving server architecture, in accordance with an embodiment of the invention;

FIG. 8 is a diagram illustrating an interleaved content stream, as used in an embodiment of the invention;

FIG. 9 is a flow diagram illustrating a method for joining a peer-to-peer streaming network, in accordance with an embodiment of the invention; and

FIG. 10 is a diagram illustrating an exemplary user interface for streaming content over a peer-to-peer streaming network, in accordance with an embodiment of the invention.

### DETAILED DESCRIPTION OF THE INVENTION

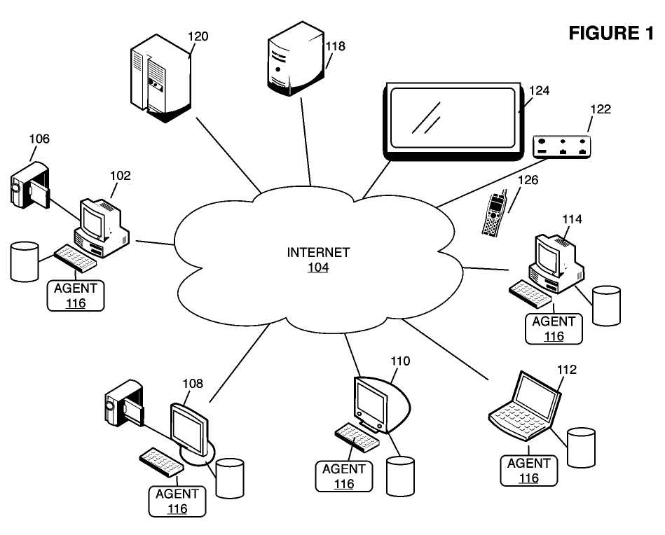

Turning to FIG. 1, an overview is described of an exemplary peer-to-peer network for multicast, real-time video streaming, in accordance with an embodiment of the invention. A content provider uses a computing device 102 connected to a public network, such as the Internet 104, and wishes to distribute content, typically from a camera 106 or other data source, to other users 108-114 with computing devices connected to the public network 104. The content provider 102 and each of the other users 108-114 are running a software or hardware streaming agent 116 on their respective computers to facilitate the distribution of the content from the content provider 102. Generally, the streaming agent 116 running at the content provider 102 and other users 108-114 notifies a directory server 118 that it is active, and the directory server 118 identifies a set of users on the network to which the content provider 102 sends its streamed content. Typically, the content provider 102 does not send the entire content stream to a single one of the identified users, but instead breaks up its content into different portions, and sends only a portion to the identified users. The streaming agents 116 running at each of the identified users, in turn, causes those users to act as content providers and send their respective portions to other users (“peers”) who may desire to receive the content. In this way, the other users 108-114 act as both content consumers and content providers to their peers. Each of the users generally receives portions of its content from multiple other users, and not from any single source. The streaming agents 116 running at each user, along with the directory server 118, optimize the distribution of the peers based on a variety of criteria, such as IP address, location within the same subnet, or the like, such that a peer only receives content from and distributes content to peers that are generally nearby according to particular metrics. In some embodiments, a streaming archive server 120 is also connected to the public network 104. The streaming archive server 120 generally acts as a dedicated content provider and is employed, for example, to stream content for users who have paid a premium. Although only a single directory server 118 and archive server 120 are shown, additional directory servers and archive servers may be added and/or distributed across multiple geographic regions, such as in proportion to the number of estimated peers within a region.

In greater detail, both content providers and content consumers may be considered “peers” on the network. In embodiments of the invention, a peer is a computing device connected to the public network 104, running the streaming agent 116 as software or hardware. Through the streaming agent 116, peers can simultaneously provide and consume content. While providing content, a peer typically serves live or archived content to consumers within the peer-to-peer network. The streaming agent 116 preferably includes modules for interfacing with media input and output devices, such as video cameras or other audio/video capture devices, along with media content stored on a hard drive or other personal persistent storage local to the peer.

While consuming content, a peer generally collects stream fragments from multiple other peers, rather than from a single source. The peer assembles the fragments for instantaneous usage. Additionally, rather than store the entire stream, peers store fragments of received content streams locally, and retransmit those fragments to other peers according to the streaming protocol employed by the streaming agent 116. Peers connect to the directory server 118 as needed, such as when joining the network.

In an embodiment of the invention, the peer 108-114 also acts to monitor content. The monitoring is performed for any of a variety of purposes, such as collecting data for enabling optimizations to improve quality of service, or to police the peer-to-peer network by detecting streams that are broadcast illegally (e.g., copyrighted material that is not being transmitted with the owner's permission) or include objectionable content. The monitoring functions of a peer 108-114 are typically performed outside of the user's control, and may be hidden from the user altogether. The peer 108-114 can perform any of several monitoring functions, including spot checks (e.g., searching particular streams believed to have high probability of illicit behavior), fingerprinting (e.g., checking against a database of copyrighted content and content profiles to determine potential copyright violations), alerts (e.g., notifying the directory server 118 of potential violations) or statistics gathering (e.g., collecting data on the upload bandwidth, download bandwidth, locality, storage capacity, uptime, processing power and/or other relevant data for the peer 108-114).

In addition to supporting the broadcast of live content, some embodiments of the invention include a streaming archive server 120, which is preferably a distributed server network for allowing a user to store content. The archive server 120 comprises dedicated servers for premium content in order to provide high availability and maximum guaranteed levels of durability. The archive server 120 may also use peers to provide local storage for content, though such storage may not necessarily provide any guarantee of availability. The archive servers 120 share their available bandwidth with the peers; hence, the archive servers 120 support the peer-to-peer streaming platform by distributing the bandwidth load for streaming. Archived content is stored on the archive servers 120 and on peers located throughout the peer-to-peer network. The archive server 120 continuously analyzes peer properties such as uptime and usage patterns, and uses this information to distribute (or redistribute) content among peers and dedicated servers to optimize levels of service for various customer classes (e.g., standard level, premium level tiers, etc.). The archive servers 120 use the help of the peers to distribute the media. Due to the dynamic nature of a peer's uptime, content requested from the peers may not always be available or complete. Content that cannot be retrieved from peers can be retrieved from the archive servers. The archive servers 120, however, are not necessary for the general functioning of the peer-to-peer platform, and they employ algorithms designed to minimize the platform's dependency on dedicated servers by attempting to predict peer availability and store content on peers appropriately. The archive server 120 communicates with the directory server 118 to provide a list of archived content, the location of archived content, whether or not the content is available, and if the content has been retrieved after a request. In these ways, the archive servers 120 provide dedicated storage for content providers in order to guarantee high availability and high durability.

The directory server 118, as used in embodiments of the invention, stores metadata for the peer-to-peer network. It interacts primarily with peers and provides a web-service interface that can be accessed by administrators. The directory server 118 preferably operates out-of-band from the actual streaming of content, yet provides a combination of several services to support the platform. The directory server 118 manages and authenticates user account, for the benefit of content users who wish to restrict access to their content. The directory server 118 also maintains a stream database (e.g., a record of all active streams in the system), and maintains a digital fingerprint database (e.g., keys that are used to identify instances of copyrighted content), so that it can take appropriate action of stopping an illicit stream, notifying the copyright owner, and/or preparing an investigation into an alleged offense. The directory server 118 manages peers by maintaining a list of available (i.e., online) peers and their capabilities such as upload/download speed, locality, storage capacity, uptime, and processing power. The directory server further maintains an archive database (e.g., records of all archived content and the locations of that content, which are updated when peers join or leave so that the database can provide details concerning content that is archived but temporarily unavailable).

In an embodiment of the invention, owners of copyrights submit the titles and registration numbers of their copyrighted material to a central administrative service, and a copyright crawler constantly scans streamed and archived profiles (first use) for matching keywords within all descriptions of the profile. When the crawler finds matches, it sends alerts advising the copyright owner to check that particular streamed or archived content for copyright infringement. If there is an alleged copyright infringement taking place, the copyright owner can report the streamed or archived content to the central administrative service, which can pursue the appropriate remedy, such as instantly shutting down the streaming of that content. The crawler identifies content for analysis based on usage patterns and stream properties, such as length and popularity (e.g., a popular feature-film length stream may be tagged as a potential bootleg).

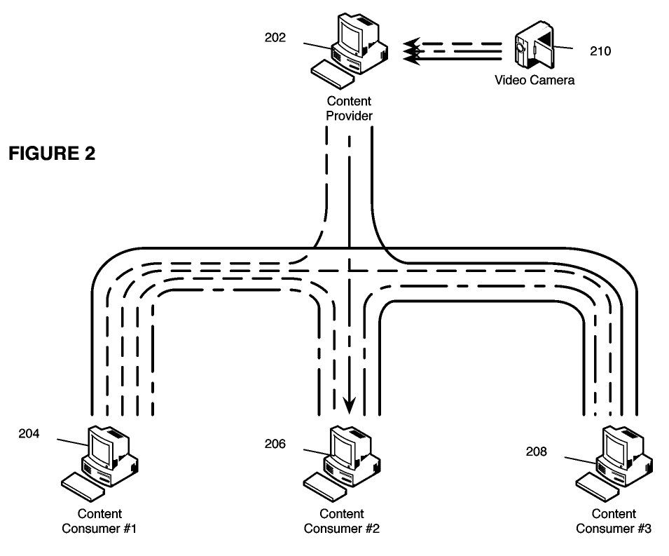

The general operation of peer-to-peer streaming as performed in embodiments of the invention is now described with reference to FIG. 2. Peers 202-208 are organized into a P2P network with a directory server managing the network. The peers 202-208 use a streaming protocol to broadcast and receive streaming content. A content provider 202 sends portions of the stream to content consumers 204-208, which cooperate to replicate the fragments among each other to obtain the full stream. After content consumers 204-208 have downloaded stream fragments, the bandwidth load is distributed more evenly since the content is stored in a distributed fashion across peers. In greater detail, in the example shown, the content provider 202 uploads a live video stream from a video camera 210. A streaming agent running at the content provider 202 instructs the content provider 202 to send a first fragment of the stream to one peer 204, a second fragment to a second peer 206, and a third fragment to a third peer 208. On a larger scale, the content provider 202 may send its content to more than three peers. Streaming agents running at each of the peers 204-208 instruct the peers to send their respective fragments to other consumer peers. In this way, a content consumer receives, in this example, one third of its content directly from the provider 202, and two thirds from other peers. On a larger scale, content consumers might receive all portions of a content stream from peers, and may not receive any content directly from the content provider 202. Notably, the upload bandwidth requirements for the content provider 202 are independent from the number of content consumers.

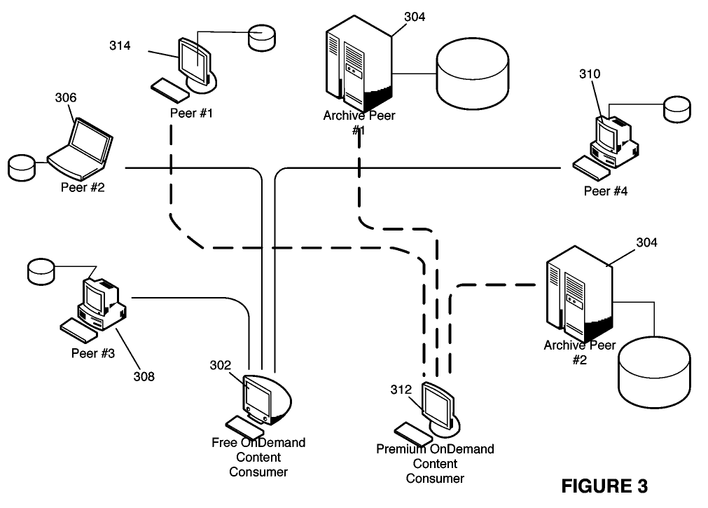

With the inclusion of streaming archive servers, the P2P network used in embodiments of the invention can be used for both live and video-on-demand services, and at varying tiers of service, as shown in FIG. 3. One content consumer 302 is receiving archived content without the use of the archive servers 304. This consumer 302 receives stored content that is distributed across peers 306-310 on the network. The availability of the content in this scenario is dependent on the availability and constraints of the peers. In one model, free, on-demand services store most of their data on peers' local storage, so high availability and durability are possible, but not guaranteed. In contrast, a second content consumer 312, having paid a premium for the right to do so, is receiving archived content that is stored on distributed archiving servers 304, which guarantee high availability and durability of the content. The second consumer 312 need not receive all portions of the content from archive servers 340, however; regular peers 314 may also serve content to the consumer 312 as availability allows.

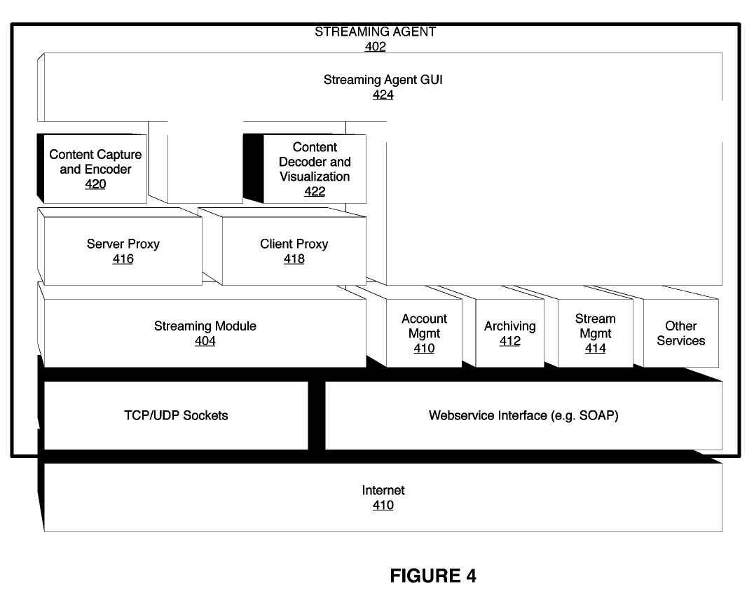

Turning to FIG. 4, the streaming agent 402 running at each peer of the P2P network is described in accordance with an embodiment of the invention.

The streaming agent 420 combines the roles of content consumer and the content provider. The streaming agent 402 is preferably available as a binary download from a central website and is thereafter installed on a user's system. The streaming agent 402 may be installed manually by a user on the peer computing device, or may be pre-installed as hardware or software on the device. Typically, the streaming agent 402 works in conjunction with a web browser, such as Internet Explore, Firefox, Safari, etc., and also with a media player through which the streamed content is viewed. Alternatively, the streaming agent 402 is embedded in device hardware, and the hardware is coupled to a viewing device, such as a television. The streaming agent 402 allows a user to connect to the P2P network, and to send and receive live or on-demand streams. A streaming module 404 of the streaming agent 402 interfaces with UDP/TCP sockets 406 as well as web-services 408, such as SOAP. These interfaces give rise to a connection through the Internet 410 to the directory server as well as other peers (more specifically, to the streaming agents running on those peers). The streaming module 404 provides the streaming agent 402 with an interface to send and receive data packets in order to facilitate the representation of a content stream. The streaming module 404 is responsible for the distribution and assembly of data fragments to and from peers (including content providers and archive servers) and achieves this by executing algorithms of a streaming protocol, such as determining from what peers to obtain chunks for consumption.

The streaming agent 402 provides additional services in the form of web service interfaces, in support of the functions performed by the streaming module 402. These interfaces interact and exchange data with the directory server. Some of the web service application programming interfaces can be used to provide information or retrieve data. For example, an account management module 410 is used for communicating with the directory server to allow a user to manage account settings, and to retrieve access privileges for particular users that can be compared to access permissions required to watch a streamed media file and deny or grant access accordingly. An archiving module 412 is used for coordinating the use of a peer's local storage for archiving purposes. A stream management module 414 allows a peer to search for streams (any kind) based on properties such as titles or description and connect to them. The stream management module 414 is also used to set up new streams if the peer is a content producer.

In addition to modules exposed to external interfaces, the streaming agent 402 preferably includes a server proxy 416 and a client proxy 418. The server proxy 416 supports content provider functionality by receiving an encoded stream on one end from a content capturer and encoder 420 and interfacing with the streaming module 404 on the other end to send the stream through the P2P network. A client proxy 418 supports the content consumer functionality by receiving streamed data from the streaming module 404 and producing a valid stream (HTTP, MMSH etc.) on the other end that a media player or other software/hardware can interpret. In embodiments of the invention, a content decoder and visualization module 422 of the streaming agent 402 is used to decode and assemble stream fragments.

The streaming agent 402 also includes a streaming agent graphical user interface 424 with all the APIs provided by the underlying services and proxies. The GUI 424 preferably contains basic logic and defers processing to the blocks it is built on. The GUI 424 is preferably completely interchangeable or generic, so that it can be replaced with another GUI without disrupting the function or operation of the other streaming agent 402 building blocks.

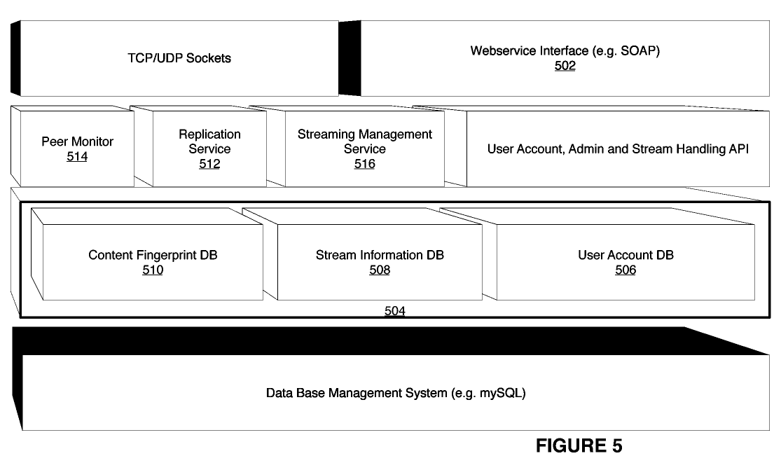

The directory server, as used in an embodiment of the invention, is now described in more detail with reference to FIG. 5. The directory server includes an interface (e.g., web services) 502 that provides peers the ability to interact with the P2P network through the Internet. Typically, a peer notifies the directory server of its existence upon initialization or login, and typically provides information describing the peer's system, its properties and user preferences. The directory server discovers the peers' public Internet Protocol (IP) addresses and the NAT type used. This includes the UDP port/IP address combination used by other peers over the P2P network to send packets to a particular peer. Thus a peer in the network can rely on the directory server to resolve its IP connectivity, especially if it is located behind NAT boxes (which are common for DSL subscribers), or if the directory server is considered a collection of distributed servers and two distinct servers are needed. While NAT boxes shield peers from possible attacks from the outside, they also make it difficult to communicate with peers. Embodiments of the invention use the directory server as a resolution service to “hole punch” through the NAT boxes to find a way to communicate with peers.

Associated with the directory server is a database 504 that stores information about the peers and the content stored and/or streamed over the P2P network. The database 504 retains historical information that guides performance optimizations and that is utilized by a self-tuning replication algorithm. Different components of the P2P network may use parts of the database 504 to store and/or access information and history about other components, including the user and all actions/processes taking place within the P2P network. Subcomponents of the database 504 may be divided in logical databases that may run in the same or separate physical databases. Also, in some embodiments, tables are split and distributed geographically by assigning certain identifier spaces to particular sets of physical databases (potentially one). The database 504 itself is mirrored or replicated in some embodiments to distribute load and/or for backup protection.

One subcomponent of the database 504 is a user database 506 that contains information about registered users. Another subcomponent is a stream information database 508 that contains information about a stream's properties, such as title, description, resolution, duration, owner, etc. The stream information database 508 also contains access control information, which allows producers to specify who can access their content, and stores the information that is used by the stream management module. An archiving database (not shown) stores information about content relevant to corresponding components. In some embodiments, a fingerprint database 510 storing identifying information about streamed content is available for identifying copyright infringements.

The directory server includes several modules to perform a variety of services in support of the P2P platform. A replication service module 512 identifies objects in need of replication and identifies potential replicas. It then assigns replication jobs based on available storage and bandwidth at the appropriate peers. The replication service module 512 also takes into account whether peers are currently active in a streaming session or otherwise accessing content on the P2P network. Additionally, the replication module 512 communicates over the P2P network in order to transfer content as a result of a replication request. Replication may be triggered by factors such as a scarcity of replicas of the object (i.e., its availability or available bandwidth does not meet the demands of the system), an increase in the popularity of an object (i.e., more replicas can be created to provide enough bandwidth to serve new content consumers) or an increase in the level of reliability guaranteed for an object. In some embodiments, replications are also performed proactively in a predictive manner to increase the chance for content to be available locally whenever a user requests it in the future. In such an embodiment, the replication module 512 can take into account a user's preferences and/or historical usage pattern to predict which objects will be requested and how many replicas should be created to meet demand. Additionally, a user might be divided into potentially many groups based on past content request patterns in order to further guide proactive replication. In an effort to reduce the overhead of making a given content available on many peers, the replication module 512 may opt to proactively replicate only the first portions of streaming content, with the goal of reducing the initial buffering and warmup time between a request for content and its rendering at the client.

Occasionally, a peer may lose data packets from their local storage, temporarily or permanently, for any of several reasons: user deletion, hardware failure, system deletion (to make room for other chunks), user is offline. Thus, the directory server includes a peer monitor module 514 that queries the database to find replicas of such lost objects with the same high probability, when those objects are no longer available from the storing peers. This loss prediction can then be used to adjust/guide the replication strategy.

The directory server also includes a streaming management module 516 and a user administration module 516. The streaming management module 516 allows management of the properties associated with streams and users, such as stream title and description and, for example, user roles and access permissions to the system and individual streams. The streaming management module 516 on the directory service interfaces with the stream information database and exposes several APIs through a webservice interface 502 to make the information available to streaming agents.

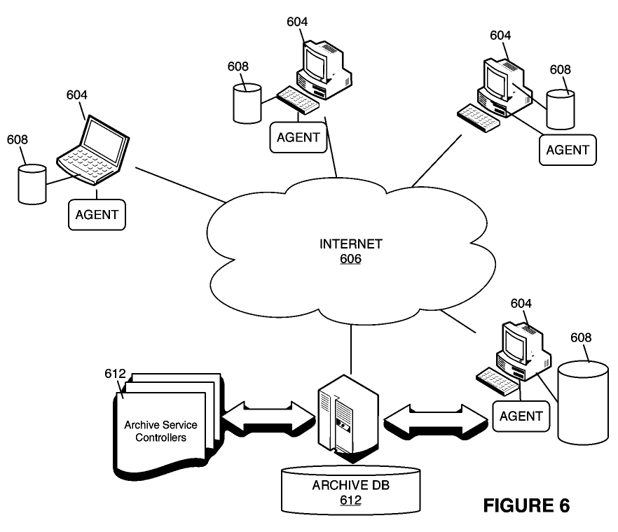

As previously mentioned, some embodiments of the invention include an archive and storage system that store portions of live/archived streams for later use, make these streams available for use by other peers on the P2P network, and access content stored by other peers for viewing. A distributed server network for archiving is now described with respect to FIG. 6. The distributed archiving server network archives content, and provides dedicated storage servers to guarantee high availability as well as high durability, thus supporting content providers by distributing the bandwidth load for their streams. The archiving server replicates archived content at peers, and interacts with the directory server to maintain a list of archived content.

Load within the distributed archiving server is balanced according to peer performance according to network position/locality and performance characteristics, such as those previously mentioned, including: geographical location of peers, location of peers within subnet, uptime, upload and download bandwidth, processor speed, available local storage, etc. Content can be stored locally at peers 604, which may be arbitrarily distributed throughout the Internet 606 and generally provide relatively low levels of reliability, bandwidth and storage. A data warehouse 608, which consists of servers distributed worldwide, provides reliable storage with high bandwidth and copious capacity. Locations of all replicas are maintained by the archive database (ADB) 610, which interacts with Archive Service Controllers 61 to maintain the requisite level of object replication to the meet platform demands.

Archives within the distributed archive server consist of dedicated servers used primarily for premium content, but which are also preferably available to enhance the performance of all content distributed over the P2P network. The local storage provided by peers 604 are primarily responsible for the storage of content for free service storage, however premium content may also be stored locally with peers to enhance system performance. Peers participate in the P2P network by receiving content and re-sending content to other peers. In doing so, peers store fragments of content streams. A peer may store stream content that it consumes, thus providing additional replicas at no additional cost to the system. The decision of whether to store such content may depend on factors such as available storage at the peer, the popularity of the content and the number of existing replicas for that content.

In embodiments of the invention, a central or distributed administrative service controls how, when, and where content is stored and accessed. A hierarchical organization is combined with node-virtualization to create an efficient, secure, optimized virtual computer (or node) comprising many physical computers and servers located across the Internet. Virtual nodes may comprise several IP-connected hosts that are grouped in a manner to maximize throughput, reliability, durability, content quality, and/or availability for any potential content consumer.

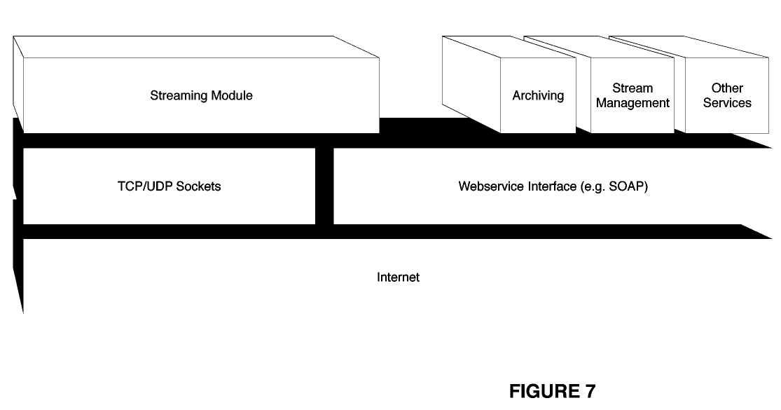

The archiving server preferably acts similarly to a regular peer running a streaming agent, except that the archiving server does not capture nor does it assemble streams. Instead, the archiving server stores content and streams content to other peers. A block diagram illustrating an exemplary archiving server architecture is shown in FIG. 7.

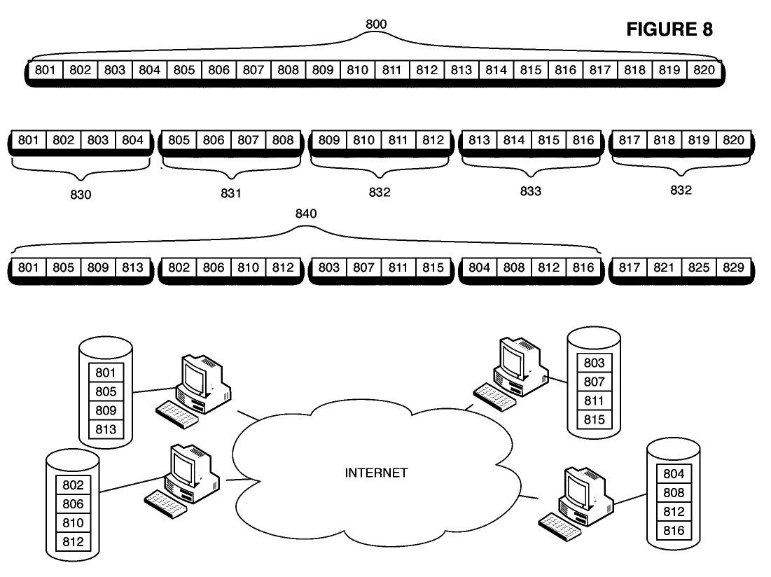

Turning to FIG. 8, embodiments of the invention store “chunks” of video (or other types of content) streams on different computers. A stream 800 of video is divided into atomic, sequential blocks 801-820. Typically, each block is a uniform size, for example, 16 kilobytes. Embodiments of the invention group blocks together into chunks 830-834 whose size is selected so as to optimize system performance. Each chunk is an independent portion of the overall video stream, and can be acted upon independently by various operations in the P2P platform. For example, each chunk can be encrypted individually, using a different key or encryption algorithm.

A video stream cannot be rendered in its entirety by a peer if the peer cannot access all of that stream's chunks. Embodiments of the invention use the archiving server to ensure that, with some very high probability, all needed chunks will be available at the required bandwidth. The archiving server determines the appropriate size for a chunk of a video stream. The number of blocks in a chunk is determined by the total size of the stream object and the rate at which the content can be delivered within both the current P2P network configuration and the expected network configuration. While a peer in some instances only streams one chunk, in some embodiments a peer streams multiple chunks to account for higher upload bandwidth availability. A table within the archiving server maps streams to chunks (one large stream maps to many smaller chunks). Chunks are then replicated at potentially many peers. The archiving server maintains a timestamp of when chunks were last available in order to detect unavailable chunks in the network. The archiving server preferably uses a strong checksum or checksum-like technique (e.g., SHA-1 of various lengths) to detect potential corruption of chunks.

Chunks may resolve to sequential ranges within a content stream or can be interleaved, potentially in proportion to the block size. In the simple sequential scheme, blocks 0 . . . n belong to the first chunk for a particular content, then (n+1) . . . (2n) belong to the second chunk and so on. In the example of FIG. 8, chunks comprise blocks 801-804, 805-808, 809-812, 813-816 and 817-820. With interleaved alignment, a pre-specified number m of chunks are interleaved. All blocks 0, m, (2m), . . . belong then to the first chunk, blocks 1, (m+1), (2m+1), (3m+1), . . . belong to the second block, and blocks (m−1), (2m−1), . . . form the mth chunk. These m chunks together can be considered a “super chunk” 840. These super chunks may either be aligned interleaved or sequentially similar to the scheme with blocks. In the example 800 of FIG. 8, the first interleaved chunk 830 comprises blocks 801, 805, 809 and 813, while the second interleaved chunk 831 comprises blocks 802, 806, 810 and 814, etc. The interleaved chunk beginning at 817 would start the next “super chunk”. Using interleaved blocks for archived storage provides potentially more available bandwidth while at the same time reducing the individual bandwidth burden on each serving peer. Each interleaved chunk my be stored at a different peer, as shown. With m interleaved chunks, the effective bandwidth requirement is reduced to 1/m for each peer serving content, when compared to the sequential setup.

Depending on the properties of the encoding scheme of the content/chunks, the unavailability of a chunk in the interleaved scheme (and thus, the unavailability of every mth block) may be handled at the application layer (e.g., the media player). For example, it may attempt to recover the lost block/chunk or simply deliver a slightly reduced user experience. In any case, content missing a chunk can still be accessed by users with minimal disruption, whereas content in the sequential scheme cannot.

By using higher order superchunks and interleaving, bitrate scalability can be achieved. That is, a peer need only upload at a fraction of the stream's actual bitrate in order to satisfy the consumer's demands. Similarly, a peer whose upload bandwidth is below the stream's actual bitrate can nonetheless participate in serving content in the P2P network. The streaming protocol is thus able to utilize sub-optimal resources within the network and is thus able to maximize the utilization of all resources available.

The storage system performs steps to prevent unauthorized use or misuse of content stored in the P2P network. In one embodiment, the content is obfuscated such that it is rendered useless to all software except that which has been explicitly authorized to access said content. For example, in some embodiments content is stored in encrypted form on a peer's local storage device, thereby preventing users from accessing such data outside of the P2P platform. There are a number of different encryption schemes ranging from simple interleaved ordering, to partial or full byte rearrangement or altering to the usage of more advanced cryptographic techniques such as symmetric or asymmetric key cryptography. A combination of the aforementioned schemes with some piece of information, potentially a key (cryptographic or rearrangement/altering scheme), stored in the directory server that is only shared with legitimate, registered users is preferably used to provide security and utility for the P2P network while reducing the total performance overhead. Additionally, in an embodiment of the invention, a peer generally does not have all portions of a stream on its local storage, so even if encryption is cracked with respect to locally stored portions, it is not possible to assemble the entire stream with encrypted portions provided by peers.

In embodiments of the invention, a chunk is assigned a global unique identifier (GUID) based on the byte-content of that chunk. The GUID is calculated such that the likelihood of different content being assigned the same GUID value is vanishingly small. Also, because each chunk is identified by a GUID based on its byte-content, chunks that contain the same byte-content, yet belong to different streams, are accounted for exactly once. Embodiments of the invention locate peers that store part or all of a particular chunk by utilizing the directory server and using the chunk's GUID initially assigned to them. Once such active peers are discovered, clients may simultaneously fetch blocks for a given chunk from multiple peers. The streaming protocol employed by the streaming agents preferably includes an adaptive read striping technique to adapt quickly to changes of available bandwidth and departure/failures of participating peers.

Chunks are preferably stored on peers and in the archive server. The machines forming the latter typically have several 9's (e.g., 99.9999. %) of uptime, vast storage, and high bandwidth. These nodes are used to ensure that there is a copy of a particular object. The peers are used to share the bandwidth demand and storage burden. Many different factors are preferably calculated to determine the optimal storage configuration, including, for example: peer upload/download time, peer geographical location, peer storage capacity, and peer processor speed, and peer typical uptime.

Two different types of replicas are used for storing chunks in embodiments of the invention. Primary replicas are full copies of a particular chunk. The archiving server always provides primary replica chunks. Chunks that are in the process of downloading or have already downloaded to peers are secondary replicas. With reference to FIG. 3, the archiving peers 304 have received primary replicas, while the consumer peers 306-314 receive secondary replicas. If the demand arises, secondary replicas can be promoted to primary. Secondary replicas can discard their copies whenever they need to free space, for example, to store new content. A primary replica is expected to have more reliability than a secondary one.

Reliability can be defined in terms of the accessibility of certain content with a certain quality of service (QoS). Since there is not a central control of when peers enter and leave the system, the archive controller records peers' uptime and downtime behavior, searches for patterns in this behavior, and uses information about known patterns to guide replication decisions, so as to provide high reliability. To support popular content, many peers typically create local copies of the content that are then promoted to primary replicas so that other peers can access them.

In embodiments of the invention, a central or distributed administrative service keeps track of both bandwidth and data availability in the centralized database. This helps ensure that there are at least three to five copies around for the first version of a stream. This value may change according to system behavior.

A number of optimizations are preferably used to improve performance of the streaming protocol. For each peer, a predefined number of “slots” are used, each corresponding to a link to a communication peer, in order to create a “social network” through the archiving server. Costs and weights are assigned in order to find the optimum settings. The social network is created through empirical observation to find and optimize in the common case. The directory server contains a recent list of active peers. When a peer joins the P2P network, it is given a good starting point to make the join process fast. “Network coordinates” are used to find a good set of initial peering partners based on geographic location and performance expectation.

Additionally, as noted above, peers receive packets from multiple communication peers simultaneously. The streaming protocol assures that peers receive each packet only once, each potentially from a different neighbor. Consequently, peers serve packets to other peers while they are receiving packets.

In embodiments of the invention, peers select other peers from which to receive streamed packets in an optimized manner so as to increase performance. By selecting peers that are near one another (in the network sense) and that have high bandwidth, a peer is likely to receive high quality of service; however, the system can become susceptible to unavailability due to local outages. On the contrary, selecting peers that are far apart, such as in disjoint ISPs or archive servers, for example, leads to higher reliability by distributing chunks throughout the Internet, but can lead to performance problems due to limited bandwidth along the long paths between peers. Given the current state of the network, embodiments of the invention balance the effectiveness of each option—some peers selected are close and others are far. In some embodiments, the proximity of peers is determined through a combination of any of number of factors, including: the peer's node type (e.g., client vs. server, customer vs. provider); the peer's upload capacity; the peer's network location (based on IP address); the peer's response time; the peer's hop distance from the source; the AS in which the peer resides; and the peer's type of connection.

Embodiments of the invention also consider additional properties in tuning the peer selection algorithm. For example, there is a correlation between latency and available bandwidth, so there are generally more peers with high bandwidth close than far for any peer. An adaptive approach is preferably used to maintain a ratio between short links (e.g., nodes that are relatively close) and long links (e.g., nodes that are further away. Peers generally organize themselves topologically into a hierarchy (i.e., tree) formed according to a social network for data delivery, and built by each peer independently before a corresponding packet is produced. The control topology, however, is a mesh. A peer's location in the hierarchy is based on information acquired as the system progresses, such as a peer's available bandwidth, load and stream content. Peers receive non-overlapping packets concurrently from separate peers. They also sometimes serve packets to peers from which they receive packets. The measured available bandwidth distribution, which is likely to be exponential or heavy-tailed, helps determine peer selection and topology organization.

Referring back to FIG. 6, the archive database 610 is now described. The database 610 in embodiments of the invention stores information that can give rise to high QoS for preferred customers, e.g., those who have paid a premium for it. The database 610 stores a variety of information about individual nodes in the P2P network, including node availability (a set of events tied to a universal time is stored, with which a regular analysis can be performed), and the set of stream objects stored at each node. The database 610 also stores information about a stream's popularity: in addition to determining whether a stream is popular, an organized topology of support peers is utilized that is efficient for providing a required bandwidth when streams are considered to be popular based on usage. If a stream is popular, the backend assures that there is enough (support) bandwidth available to guarantee a desired level of quality of service. This is preferably done by analyzing the data of the database, e.g. detecting popular streams with bandwidth problems and then start up dedicated support peers to provide supplement bandwidth for a stream. The database 610 also stores information about bandwidth availability history. In embodiments of the invention, it is first figured out how fast a peer can download one of the highly available streams. An adaptive placing algorithm that maps stream objects to store on the peers ensures that streams, e.g. popular once, can be delivered fulfilling the required bandwidth demands. Benchmarking is then performed in the reverse direction. Historical observation and/or performance data (passive and/or active) is used to estimate the peer's current available bandwidth. Active measurements involve loading the system to its capacity to estimate its available upload and download bandwidth availability and latency. These active measurements are preferably done sporadically when an updated statistic is deemed to be necessary due to a change in the environment (e.g., joining, reconnecting to consume another stream) or other passive measurements. Passive measurements can include several indicators which are obtained while a streaming agent is consuming (downloading) from its peers or delivering (uploading) chunks to its peers. Some of these passive measurements include the latency (the amount of time it takes for a sending out a request for chunks and receiving a response) and loss rate (chunks which were not delivered on time and are thus no longer useful to the consuming aspect of the stream agent). Once that information is known, the current load is subtracted from the maximum available bandwidth to obtain an estimate. Content is placed close to where it is needed in order to facilitate satisfactory bandwidth availability. The database 610 also stores information about: available storage at each node (space is allocated on nodes as needed up to a maximum threshold based on the percentage of remaining disk space); chunks a peer is requesting; amount of progress on a particular request; and a table of ‘secondary’ peers containing all of the streams in progress. The archive database 610 is also preferably involved in authentication, as an authentication token is preferably used for exchanging chunks.

In embodiments of the invention, an archive service controller (ASC) 612 is the “brain” behind the archive service and is preferably fast and efficient. The ASC consists of potentially many controllers replicated and potentially distributed across many computers across the world, interacting to share work and ensure reliability. The ASC 612 creates leaders/service monitors in a fast and deterministic manner in order to replicate and self-organize the control load. The leader is instructed to assign an ID to a service monitor by determining the ASC 612 status and contacting other controllers to assign them tasks. The tasks they complete are typically based on their ID and are completely deterministic. The database 610 tracks information about the online controllers and the identity of the leaders. The operation of an ASC instance upon initialization is as follows: Startup; Contact Database; Determine existing controllers (If there is only one controller, it will designate itself as the leader.); Insert self into database; Determine responsibilities based on other controllers

The ASC 612 also responds to high demand by making additional replicas of data according to QoS requirements. Some of the back-end high bandwidth and high reliability storage can be utilized while making the additional replicas. The controller utilizes this “crutch” while data is being duplicated and transferred. This operation is planned so the back end servers are used as little as possible. Streaming is high priority and is preferably never interrupted. Hence, a low priority data transfer may be employed for replication.

The ASC 612 further accesses the table of ‘secondary’ peers. With this information, the ASC 612 points peers that recently joined the stream to those further along in the stream, yet not complete. The ASC 612 also ensures data durability by using known algorithms, (e.g., lifespan prediction based on current uptime, or MTTF (mean time to failure) based on historical data) to provide certain levels of reliability. Additional functions performed by the ASC 612 include: determining future availability; determining future bandwidth and data availability; determining how loaded a peer is in terms of bandwidth and other performance limiting factors; interacting with the database 610 to find peers that house a particular chunk; and issuing commands (through the directory server) to peers to replace content. The ASC 612 follows an object priority scheme to replace content, dependent on how the replacement operation could affect the whole system. The system preferably estimates the expected completion of replication on a continuous basis using aforementioned active and/or passive measurement information.

Additionally, in embodiments of the invention, the ASC 612 is in charge of launching the following daemons, which are tasks that run indefinitely: client checking (i.e., determining whether nodes are still alive and recalculating their availability. The client contacts the database upon startup and clean shutdown. The controllers otherwise periodically ping. They can also hierarchically ping each other.); stream checking (determining popularity of active streams and ensuring availability is there in terms of bandwidth); object durability checking (making sure objects are sufficiently durable); object distribution (taking a list of object replication requirements and fulfilling them); controller monitoring (making sure controllers are online, updating responsibilities on joins/leaves, redistributing peers/objects to other controllers as necessary).

As previously discussed with respect to FIG. 4, peers have streaming agents executing to participate in the P2P network. These agents contain archiving modules 412 to determine what content gets stored on a peer's local storage. The archiving module 412 executes commands from the controller (such as fetching content, removing content, and reordering priorities) and reports with status updates on the executed commands. The commands are obtained via either a push model or a pull model. Depending on the size of the system and the type of command, the archiving module 412 may be required to contact the ASC to determine whether there is a command. This will work when there are few enough peers contacting the ASC with low frequency. When this is not the case, the system uses a push model, whereby the ASC contacts each archiving module 412 individually with a command, or issues a command that is distributed to many archiving modules over an efficient topology formed by the archiving modules.

Still referring to FIG. 4, the streaming module 404 executes a streaming protocol to receive and distribute content in an embodiment of the invention. The streaming protocol is a data distribution algorithm that uses the bandwidth resources of all participating peers. Embodiments of the invention are used with streaming applications where a media source streams live content to a potentially large number of receivers. These receivers may join and leave the streaming session at any time. Additionally, embodiments of the invention can also be applied to archived content. Peers may access the archived content at any time. In archive scenarios, peers access the (mostly sequential) content from the beginning to the end of a media file. Additionally, multiple peers may access the same archived content simultaneously. In both of these two scenarios, one logical overlay topology per actively distributed/accessed content is maintained.

The streaming protocol leverages a mesh topology to organize participants into a peer network. In such a network, each peer has a variable number of virtual connections to other peers in the network over which it exchanges control information. The mesh interconnect is rich in order to guarantee a low maximal network diameter even for large networks. Preferably, the size of information (state) maintained for each such mesh link is minimal at each host to ensure scalability. The streaming module 404 further limits the number of control links a peer maintains. The links used for data exchange are a subset of the control links.

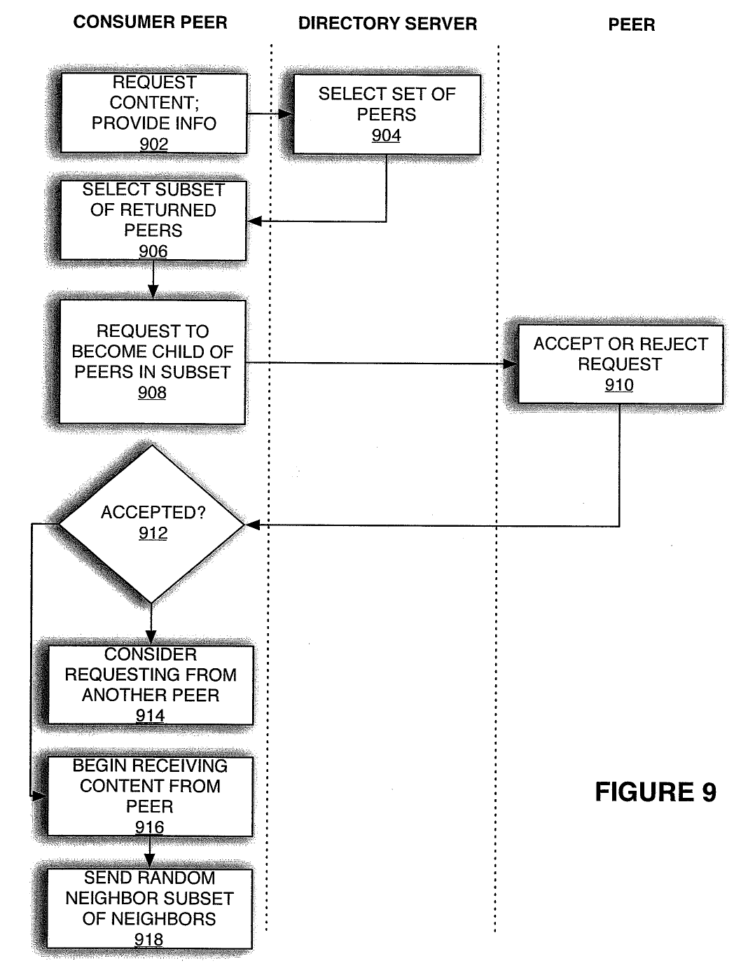

Turning to FIG. 9, a method for a peer to join the hybrid P2P network and receive content is now described, in accordance with an embodiment of the invention. A content provider registers its streaming or archived content with the directory server, which, as noted above, can be a centralized or distributed service. The directory server stores information pertaining to all content within the P2P network. Peers acting as content consumers contact the directory server to query existing content, potentially applying search queries.

To access specific content, a peer contacts the directory server at step 902. After successful authentication, the directory server returns at step 904 a set of peers that are part of the P2P network corresponding to the requested content. As an optimization, the directory server implements a filter, and may require peers to submit a network coordinate along with their join requests. These coordinates can be any collection of data that reveals information about the peer's physical position in the world and/or logical position in the Internet. Additionally, information regarding the peer's available bandwidth might be passed with the join request. Alternatively, the directory server may have a historical record of that peer which reveals potentially the same amount of detail. Based on this received or historical information, the directory server selects and returns a subset of the currently joined peers. To serve future joins more efficiently, it keeps a log of the network coordinates of each peer within the P2P network. The selection of the peer set returned to a join request can be based on one or more policies based on any combination of the following properties: join time, IP address, ISP's Autonomous System (AS) number, Internet distance (latency or hop), physical distance, or bandwidth availability. Some of the properties can be applied to the media source and/or the joining peer. A number of statistical methods can be applied to select from one or more lists of annotated peers and sort by such properties.

Once a peer receives a list of peers from the directory server, the peer evaluates this set of participants and establishes a fixed number of initial connections in which it becomes a child of each of the set of peers (referred to as its parents) at step 906. The peer applies additional policies to filter the list of peers based on its personal historical records and/or alternate data it may have gathered earlier or during the join process.

The requesting peer contacts the selected subset of the peers with a join request at step 908. If a peer is willing to accept a new child peer, it acknowledges the request at step 910—otherwise, it rejects it. Due to the nature of the system, a join request may fail or be refused, as determined at step 912. In this case, the joining peer may, at step 914, reconsiders unused entries returned from the directory server or considers active child peers from previously contacted nodes. In an embodiment, a peer sends along a list of its current children with the answer to the join request. In any of these cases, the root node may be part of the set of peers, so that a small number of content consumers connect directly to the content provider. The consumer peer then begins to receive content from the subset of peers at step 916.

As the network steadily grows with new peers arriving, existing members learn about them in order to add new mesh links. For this purpose, each peer selects a random peer among its current neighbors and sends a subset of its current neighbors to that peer at step 918. This set is filtered similar to how the directory server filters the initial set of peers after joining. Whenever a peer receives such a membership announcement from any other peer, it reevaluates its current neighbors and potentially adds one or more of the peers contained in the received set. To limit the total system overhead, the number of membership announcements sent and/or processed by the peer can be limited for any given time interval. The average number of membership announcements is preferably limited to one per peer per minute, not accounting for announcements sent as a response to a join request.

In embodiments of the invention, media content is distributed in the mesh formed by all the participating peers. Every peer has children and parents in the distribution topology. The sets of children and parent peers may overlap or be disjoint; thus, a parent-child relationship can be bi-directional. Content is passed from parents to its children only. The media content is distributed into smaller blocks that are typically the size of a video frame and may be variable in specific size.

For streaming applications, the media source pushes new content out to its children. It may send one or more copies of each block to multiple peers, but not twice the same to one peer. Given the knowledge of the source about other first tier peers, it may require a peer to forward a data block to a subset of these peers in order to increase the number of copies of a block in the system. Hence, a receiving peer is responsible to forward the blocks when requested by the source, or to inform it about its inability to honor the forwarding request. This technique therefore builds instantaneous multicast trees for each packet that includes a core subset of the peer population. In this manner, the source essentially seeds the network with copies of the blocks before each peer starts serving blocks to their children via individual requests. This greatly reduces the end-to-end delivery latency while better balancing the load among the participants. In such an arrangement, the core subset may contain a different subset of peers for each packet of the stream. Additionally, peers may be selected based on its capacity to be selected as part of such a subset. Since the publisher ideally only sends each packet once, a distribution tree for each subset is formed instantaneously. In some embodiments, this is implemented recursively where the source only defines the first receiver and the first tier. Then, while forwarding the packet to the first tier, the second tier is defined by the first forwarding load in an effort to reduce complexity and overhead.

A peer piggybacks and/or sends separate block announcement messages to its children in the mesh. The messages contain a list of currently stored blocks at the node, called the active window. A peer may keep the active window at a fixed size and thus remove older or unused blocks after some time. After receiving a block announcement, a peer requests up to a MAX_REQ number of blocks from its parents. In an embodiment, a few requests are sent in a summary request invocation to reduce network overhead. This approach is often referred to as pull-based distribution. The total number of outstanding pull requests is preferably limited for each peer. This includes requests issued by the peer and requests received by the peer. Consequently, a block request may be denied during which a peer searches for another parent that it can request this particular block from. It may also defer the request and try again later.

In addition to the pull-based distribution above, in some embodiments peers may opt to use a push-based algorithm. To avoid duplicates, a peer needs to ensure that no other peer will forward a particular block to the same node. This is achieved by establishing a contract between parent and the requester (a child node of the parent). Embodiments of the invention use one or more techniques to establish such a relation that prevents duplicate data delivery to peers.

First, the peers can define a primary forwarding parent. This parent is contracted to forward all packets it receives provided they are reaching it in the most direct fashion. Most direct in this case means that the hop count of the packet is equal to the hop distance of the parent from the source. In other words, there is no significant delay through indirect forwarding. Consequently, that parent needs to have a lower hop distance to the source than to the requester itself. Each peer selects its primary forwarding peer(s) based on their hop distance from the source and their available bandwidth capacity. One or many primary forwarding peers can be used. Alternatively, “most direct” means being received from a parent that has higher upload utilization and/or capacity.

As the peers' available bandwidth is limited, the forwarding load is preferably distributed to all participants. Thus, a peer may require one of its children that received a block to forward it to a subset of its children, saving the burden of the parent to forward it to everyone itself. This applies both for pull-based or push-based forwarding. The number of these indirect forward requests can be defined as a function of the child's load as indicated by piggybacked information when acknowledging packets. Also, indirect forwarding may be denied by a node requiring its parent to search for another indirect forwarder. Alternatively, the parent may forward it itself.

Peers may opt to register forwarding filters at any of its parents. If a packet matches a filter, the parent will directly or indirectly forward that packet to a node. If multiple filters are placed at different parents, they are chosen so that they create disjoint forward requests.

When selecting a peer to forward content to, a peer takes into account the available bandwidth at and to its children as well as the link latency. In doing so, it aims at filling the TCP window of a link or any similar window used to enforce flow control. Thus, when it pushes out packets, it utilizes a selection policy for the nodes to pick for direct and/or indirect forwarding. In general, indirect forwarding delivers the block to the relay node as well, thus making indirect forwarding an extension of direct forwarding. By employing direct and indirect forwarding, the streaming protocol employs a special variation of multi-tree distribution scheme, where the number of utilized trees approaches the theoretical maximum defined by the permutation of all the peers. Each of the trees may look different due to random elements affecting the forwarding decision at different layers. While partial trees may match with higher probability especially when employing forwarding filters, the random element used when forwarding the blocks at the first tiers assures that forwarding trees take on fundamentally different structures.

In order to distribute the forwarding load among peers, in embodiments of the invention each peer limits the number of outstanding requests to and from it. Additionally, it allocates a dynamic number of requests for each peering partner. If these allocations are not utilized, the peer may distribute them to other partners in order to boost their throughput. The allocation is based on a policy accounting for latency (network and application end-to-end), throughput, and loss rate. Additionally, the allocation may account for the capacity at each of the nodes and their total contribution to the system.

Embodiments of the invention attempt to form a mesh topology where the end-to-end delay experienced by a parent is typically smaller when compared to that of its children, and when the available bandwidth monotonically increases as one comes closer to the source. One or more algorithms are used to reduce the total delivery latency in the delivery topology. For example, a mesh topology optimization reduces the latency by discovering close by nodes in the network. However, all these techniques aim at reducing the latency in the current mesh. While this technique is essential to assure low latency, embodiments also optimize the mesh as the partial view of the network at join time, and reorganizes the topology due to changing conditions and network loads.

Thus, a peer periodically evaluates its parent and children set, and if necessary, removes and adds new links. Additions can be made until the maximum number of links is reached. During this particular case, a peer may opt to drop a current link in favor for a new one. For this purpose, a peer ranks his parents based on an evaluation function. This function may account for link latency, link throughput, a parent's hop distance from the source, the number of clients of that parent, the number of common parent/children, and/or other performance-related factors. Typically, a peer will drop the worst link if it has been given sufficient time to be evaluated. Once dropped, a peer immediately adds a new link. The search process may have been initiated before the drop decision took place so that the successor immediately succeeds the dropped parent/child. To counter potential oscillation effects, each peer preferably keeps a history of past peering partners. It then uses this history as part of the decision on whether to add a link to a particular peer. Historical experience may also guide the data request algorithm where the number of outstanding request is adapted based on the past performance of a link/node.

Embodiments of the invention also include designated peer hardware components, as shown in FIG. 1. The designated peer hardware components have at least two variations; (1) the set-top box 122, and (2) the peer-enabled television 124. The set-top box 122 works as an add-on to existing television sets. The set-top box includes all of the hardware and software components necessary to turn the user's standard television into a streaming peer. A set-top box 122 may include, but is not limited to, one or more hard-drives, a motherboard and one or more processors, wireless/standard high-speed Internet modem and/or a conventional Ethernet connection, and other necessary computer components to give the set-top box access to the P2P network, and to function as an “ideal peer” for storing, distributing, and creating content. The set-top box 122 preferably connects directly to the user's television and to the Internet 104. This configuration allows the user to view content being distributed throughout the P2P network on their television. The set-top box 122 also has inputs that allow the user to utilize the content publishing capabilities of the streaming agent and the P2P network through the set-top box 122.

The peer-enabled television 124 has the same functionality as the set-top box, but it is not connected externally through wiring to the user's television. The peer-enabled television 124 includes the necessary hardware and software components to act as a peer within the television itself. Like the set-top box 122, the peer-enabled television 124 acts as an “ideal peer” for storing, distributing, and creating content. The peer-enabled television 124 also functions like a normal television for viewing content distributed through cable lines, DVD players, and other content providing technologies.

Additional variations of designated peer hardware components, as used in embodiments of the invention, include other embedded devices that may act as a streaming agent, such as a cellular phone 126 or portable media player through broadcast waves, satellite connection, Wi-Fi, Wimax, Bluetooth, etc. Such embedded devices can fulfill particular roles in the overall P2P network as described above, such as the replication service, publishing specific content, etc. Alternatively or additionally, a networkable (wired and/or wireless) data storage unit, having the capabilities to inject archived content into the network is used. In still another embodiment, a set of independently operating embedded devices are used to operate toward a common goal, coordinating effort and distributing data (e.g. sensory data) among themselves with limited central control, e.g., MEMS.

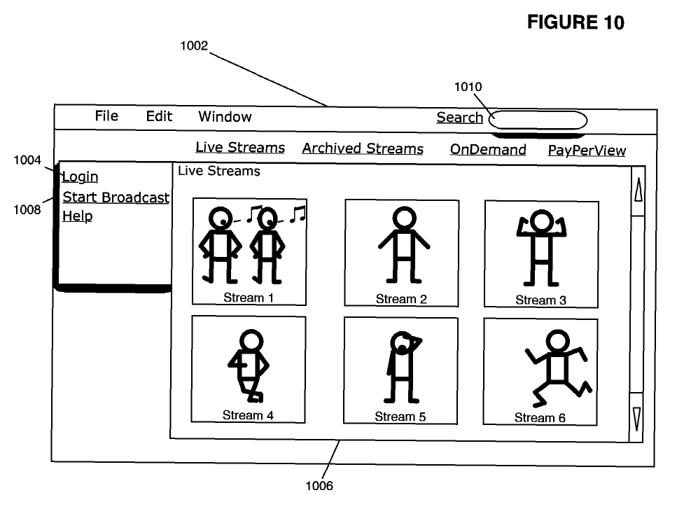

An exemplary user interface to the P2P platform is shown in FIG. 10, in accordance with an embodiment of the invention. A user accesses the interface 1002 through a web browser such as Internet Explorer, Firefox, Safari or similar browser application. The interface 1002 preferably ties in with the directory server in order to manage the overall streaming process. The user is presented several selectable options, including login 1004, stream selection 1006, and broadcasting 1008. Additional options may be presented, such as a search interface 1010. When a user logs in with the login option 1004, his computer becomes a peer on the P2P network. When the user selects a particular stream from the stream selection option, the streaming agent on the user's peer computer begins to receive the stream typically with portions arriving simultaneously from multiple sources—and, potentially, the peer serves a portion of the stream to other peers. A media player decrypts and assembles the stream for presentation to the user.

When the user selects the “broadcast” option 1008, a video camera or other input device is automatically detected, if attached, and uploading of a live stream begins. Other peers may be notified of the new stream through either out-of-band communications, or through a listing on the stream selection 1006 option. In some embodiments, a search option 1010 is also presented. When the search option 1010 is selected, the user is preferably presented with an interface whereby he can search for particular content or type of content to be streamed. Additionally or alternatively, a recommendation system makes suggestions to the user as to content streams that may be of interest. The recommendations are calculated from known user information, such as what may have been entered by the user in a profile, and/or from past streaming activity, and/or from known attributes of content streams.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. In a network of interconnected peer computing devices, a method for receiving a stream of electronic content, the method comprising:
notifying a directory server with a request for the stream;
receiving a response identifying a set of the peer computing devices from which the stream's content can be retrieved;
receiving, substantially simultaneously, at least a first distinct portion of the stream from a first peer computing device in a calculated subset of the set of peer computing devices, and at least a second distinct portion of the stream from a second peer computing device in the calculated subset; and
assembling at least the first portion and the second portion into a presentable form.

2. The method of claim 1 further comprising calculating, according to a predetermined algorithm, the subset of the set of peer computing devices.

3. The method of claim 2 wherein the predetermined algorithm takes as input one or more factors from the group consisting of:
the upload capacity of the peers in the set;
the network location of the peers in the set; and
the response time of the peers in the set.

4. The method of claim 1 further comprising:
storing, at least temporarily, the first portion of the stream; and
transmitting the first portion of the stream to another of the interconnected peer computing devices.

5. The method of claim 1 wherein the first portion contains at least two sub-portions of the stream, the first sub-portion being for presentation in a time period prior to a sub-portion of the second portion, and the second sub-portion being for presentation in a time period after the sub-portion of the second portion.

6. The method of claim 5 further comprising:
decrypting the first sub-portion according to a first decryption key; and
decrypting the second sub-portion according to a second decryption key.

7. The method of claim 1, further comprising:
ceasing to receive the first portion of the stream from the first peer computing device; and
automatically continuing to receive the first portion of the stream from a third peer computing device.

8. The method of claim 1 further comprising:
requesting the first portion from the first peer computing device;
receiving the first portion from the first peer computing device in response to the request; and
receiving the second portion from the second peer computing device without having made a request of the second peer.

9. The method of claim 1 further comprising:
generating a digital fingerprint for at least a portion of the stream's content; and
comparing the digital fingerprint with a database of known content fingerprints to determine that distribution of the content violates a policy.

10. In an interconnected network of computing devices, a system for distributing electronic content comprising:
an instance of electronic content, the instance partitioned into a plurality of substantially equally sized portions;
a source computing device for initially transmitting the instance of content onto the network;
at least one consumer computing device on the network for receiving the instance of content;
a directory server for helping identify a first set of computing devices on the network from which the consumer computing device can receive portions of the content; and
an agent executing at the consumer computing device for:
receiving the identification of the first set from the directory server;
causing distinct portions of the instance of content to be received from distinct computing devices within a calculated subset of the first set; and
assembling the distinct portions into a presentable form.

11. The system of claim 10, the consumer computing device comprising a storage device, and the agent executing further for:
storing, at least temporarily on the storage device, one portion of the content; and
transmitting the stored portion to another computing device on the network.

12. The system of claim 10, wherein the consumer computing device is a set-top box in connection with a television.

13. The system of claim 10, wherein the source computing device is a video recording device connected directly to the network.

14. The system of claim 10 further comprising an archiving server, wherein the instance of content is stored in the archiving server for retrieval on demand by the consumer computing device.

15. The system of claim 14 wherein the archiving server is distributed amongst computing devices on the network.

16. A method for broadcasting a live content stream to a multiplicity of users on an interconnected peer-to-peer network, the method comprising:
registering the content stream with a directory server;
receiving, from the directory server, a list of identified computing devices on the network to which distinct portions of the content stream are to be sent; and
transmitting a first of the distinct portions of the content stream to a first of the identified computing devices, and a second of the distinct portions to a second of the identified computing devices.

17. The method of claim 16 further comprising:
receiving a request from a computing device on the network for one of the distinct portions of the live content stream; and
transmitting the requested distinct portion of the live content stream to the requesting computing device.

18. The method of claim 16 wherein registering the content stream comprises:
logging in, via a user interface, to a central registry with access to the directory server; and
selecting, with a single selection, an option corresponding to broadcasting from a plurality of presented user-selectable options in the user interface;
wherein the transmitting of the content stream occurs automatically from a coupled input device following the registering of the content stream.

19. A method for managing the on-demand retrieval of a stream of content by computing devices on an interconnected peer-to-peer network, the method comprising:
partitioning the stream into a plurality of distinct stream partitions;
determining that a first archiving computing device connected to the network is to store at least one of the distinct stream partitions;
storing one or more stream partitions at the first archiving computing device;
receiving a request for the stream of content from a first consuming computing device connected to the network;
determining that the first consuming computing device is to store at least one of the distinct stream partitions;
storing at least one of the stream partitions at the first consuming computing device;
receiving a request for the stream of content from a second consuming computing device; and
causing the plurality of distinct stream partitions to be transmitted through the peer-to-peer network to the second consuming computing device, including at least one partition from the first archiving computing device and at least one partition from the first consuming computing device.

20. The method of claim 19 wherein determining that the first consuming computing device is to store at least one of the distinct stream partitions is based on one or more criteria from the group consisting of: the upload bandwidth of the first consuming computing device to the network; the available local storage at the first consuming computing device; geographic location of first consuming computing device; processor speed of the first consuming computing device and the popularity of the content stream.

21. The method of claim 19 further comprising:
determining that the content stream is to be guaranteed available at a premium tier of service for a subset of computing devices on the network; and
determining that storage of at least one of the content stream partitions at the first archiving computing device helps satisfy the guarantee.

22. The method of claim 19 further comprising:
monitoring the performance of the first consuming computing device with respect to serving the stored partition of the content stream;
determining that the first consuming computing device is underperforming against a metric with respect to serving the stored partition of the content stream; and
causing the partition of the content stream to be removed from availability to other computing devices on the network.

23. The method of claim 22 further comprising:
determining that a third computing device would perform better than the first consuming computing device with respect to serving the stored partition of the content stream; and
replicating the content stream partition stored at the first consuming computing device to the third computing device.
